(19) United States
(12) Patent Application Publication
(10) Pub. No.: US 2017/0240093 A1
(43) Pub. Date: Aug. 24, 2017

(54) VEHICLE LAMP HEATER AND VEHICLE LAMP

(71) Applicant: BorgWarner Ludwigsburg GmbH, Ludwigsburg (DE)

(72) Inventors: Katherine O'Sullivan, Co. Kerry (IE); Cian McCarthy, Dingle (IE); Dara O'Carroll, Tralee (IE)

(21) Appl. No.: 15/438,089

(22) Filed: Feb. 21, 2017

(30) Foreign Application Priority Data
Feb. 23, 2016 (DE) 10 2016 103 146.1

(51) Int. Cl. B60Q 1/00

(52) U.S. Cl. CPC B60Q 1/0005; B60Q 1/0017

(57) ABSTRACT

This disclosure refers to a vehicle lamp heater, comprising a PTC heating resistor, a metallic cooling body fixed to the PTC heating resistor, and a holder holding the PTC heating resistor and the metallic cooling body. Also disclosed is vehicle lamp comprising a plastic housing with a transparent cover and such vehicle lamp heater.

### RELATED APPLICATIONS

This applications claims priority to DE 10 2016 103 146.1, filed Feb. 23, 2016, which is hereby incorporated herein by reference in its entirety.

### BACKGROUND

The invention relates to a vehicle lamp heater and a vehicle lamp comprising a lamp heater.

Modern vehicle lamps increasingly contain light emitting diodes (LED) instead of halogen light bulbs. LEDs provide beneficial reductions in power consumption but do not generate sufficient heat to prevent the accumulation of condensation on the inside of the lamp's transparent cover.

U.S. Pat. No. 7,262,388 B2 discloses a vehicle lamp comprising a PTC heating resistor mounted on the lamp housing. The PTC heating resistor is provided as a series of conducting tracks arranged on an inner or outer surface of the lamp housing close to the transparent cover. However, at freezing temperatures, e.g., −20° C., deicing the transparent cover of the headlamp still takes considerable time.

### SUMMARY

This disclosure teaches how a vehicle lamp, especially a vehicle headlamp, can be deiced quickly.

A vehicle lamp heater according to this disclosure comprises a PTC heating resistor and a metallic cooling body fixed to the PTC heating resistor. The inventors have found that heat dissipation is often the limiting factor for quick deicing of a vehicle lamp. In comparison to conductor tracks arranged on a surface of the lamp housing, a metallic cooling body significantly improves heat dissipation. Hence, heating power can be increased and deicing accelerated.

PTC resistors show a marked increase of the electrical resistance at a critical temperature. The electrical resistance of a PTC resistor's low temperature state and the electrical resistance of its high temperature state may differ by a factor of 100 or more. Hence, PTC resistors are inherently safe from overheating.

The PTC heating resistor according to this disclosure may be a polymer PTC resistor, e.g., a mixture comprising carbon black particles and a thermoplastic polymer, for example, polyethylene or polyvinylidene fluoride. Polymer PTC resistors can be manufactured at low cost and offer reliable protection from overheating.

An advantageous refinement of this disclosure is that the PTC heating resistor is electrically insulated from the cooling body. For example, the PTC heating resistor may be fixed to the cooling body by means of glue or an electrically insulating adhesive.

Another advantageous refinement of this disclosure is that the PTC heating resistor is provided as a layer between two metallic surfaces. These surfaces can be used to apply an electric potential to the PTC heating resistor. For example, the PTC heating resistor can be arranged between two metal sheets. The sheets may be covered by glue or an electrically insulating adhesive for fixing the cooling body.

Another advantageous refinement of this disclosure is that the metallic cooling body can be made from corrugated metal sheet, e.g., aluminum. Such a cooling body can be manufactured cost efficiently and enables efficient heat transfer. Like fins, the corrugations provide a large surface area for transferring heat to surrounding air.

Another advantageous refinement of this disclosure is that the PTC heating resistor is arranged between two metallic cooling bodies. Thereby, heat dissipation can be improved even further.

Another advantageous refinement of this disclosure is that the vehicle lamp heater comprises a fan. A fan can improve heat dissipation by blowing air onto or through the cooling body or bodies. The holder can be used to hold a fan in addition to the PTC resistor and the cooling body or bodies.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a vehicle lamp heater;

FIG. 2 shows another embodiment of a vehicle lamp heater;

FIG. 3 shows a vehicle head lamp; and

FIG. 4 shows a different view of the vehicle headlamp of FIG. 3.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

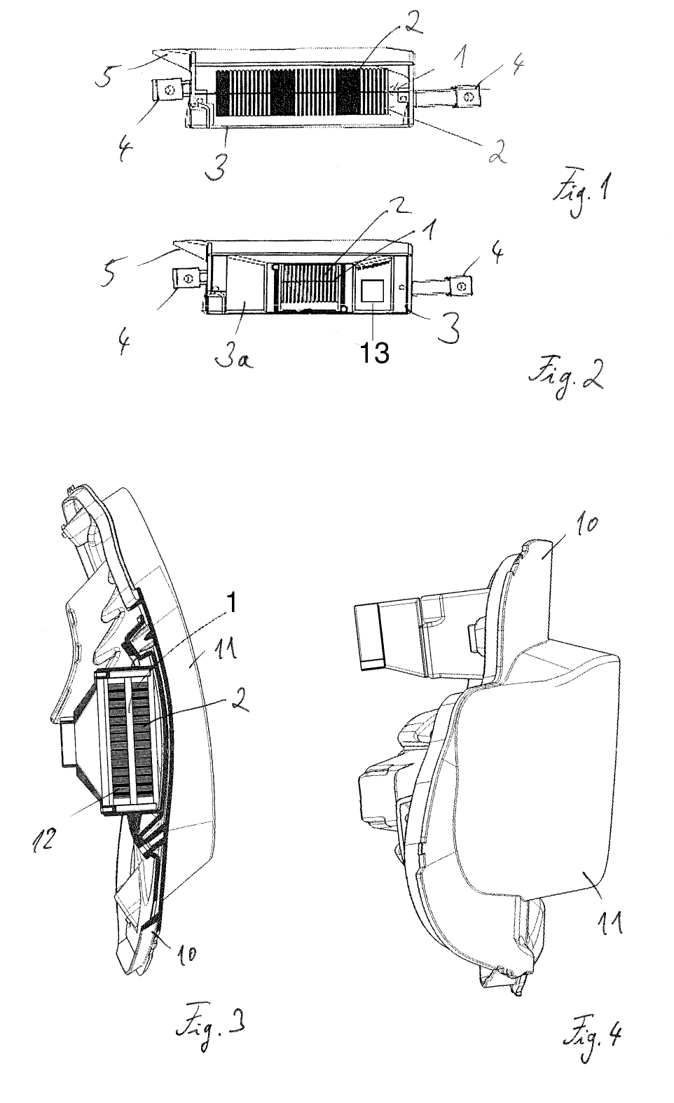

The vehicle lamp heater shown in FIG. 1 comprises a polymer PTC heating resistor 1, two metallic cooling bodies 2, and holder 3 holding the polymer PTC heating resistor 1 and the cooling bodies 2. The holder 3 is typically made of plastic, e.g., PC, PA66, PBT or other thermoplastic, and comprises attachment elements 4 for fixing the holder to a housing of vehicle lamp. The attachment elements may for example comprise an eyelet or a lug.

The polymer PTC heating resistor has a metallic coating on opposite sides. Terminals for connection to a power source, e.g., the vehicle electric system, can be attached to the metallic coating, e.g., by soldering or welding.

The polymer PTC heating resistor may be a layer provided between two metal sheets. The polymer PTC heating resistor is electrically insulated from the cooling bodies 2, e.g., by an electrically insulating adhesive or glue that covers the metallic coating of the PTC heating resistor. The cooling bodies 2 are corrugated metal sheets, e.g., made of aluminum.

The holder 3 forms a frame surrounding the polymer PTC heating resistor 1. In addition the holder 3 comprises at least one wall 5. The wall 5 or walls can form a housing wherein the polymer PTC heater and the cooling bodies 2 are arranged. Moreover, the wall 5 or walls can guide an air flow.

FIG. 2 shows an embodiment of a vehicle lamp heater that differs from the embodiment of FIG. 1 only in that a funnel-like section 3a has been added to the holder 3. Section 3a is configured to hold a fan for blowing air onto and through the cooling bodies 2. The fan 13 is shown diagrammatically in FIG. 2.

FIGS. 3 and 4 show a vehicle headlamp comprising a plastic housing 10 with a transparent cover 11, an LED (not shown), and a vehicle lamp heater 12. The vehicle lamp heater 12 may be a vehicle lamp heater as shown in FIG. 1 or 2. In FIG. 3 metallic cooling bodies 2 of the vehicle lamp heater 12 can be seen. The vehicle lamp heater 12 is arranged in a slot in the bezel of the vehicle lamp.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A vehicle lamp heater, comprising:
a PTC heating resistor;
a metallic cooling body fixed to the PTC heating resistor; and
a holder holding the PTC heating resistor and the metallic cooling body.

2. The vehicle lamp heater according to claim 1, wherein the metallic cooling body is formed of corrugated metal sheet.

3. The vehicle lamp heater according to claim 1, wherein the metallic cooling body is electrically insulated from the PTC heating resistor.

4. The vehicle lamp heater according to claim 1, wherein the metallic cooling body is fixed to the PTC heating resistor with an adhesive.

5. The vehicle lamp heater according to claim 1, wherein the PTC heating resistor is arranged between two metallic cooling bodies.

6. The vehicle lamp heater according to claim 1, wherein the PTC heating resistor has a metallic coating on two opposing sides.

7. The vehicle lamp heater according to claim 1, wherein the holder is made of a thermoplastic.

8. The vehicle lamp heater according to claim 1, wherein the holder comprises a frame surrounding the PTC heating resistor.

9. The vehicle lamp heater according to claim 1, wherein the holder holds a fan.

10. The vehicle lamp comprising a plastic housing with a transparent cover and a vehicle lamp heater according to claim 1.

11. A vehicle lamp heater, comprising:
a PTC heating resistor;
a metallic cooling body fixed to the PTC heating resistor;
a fan; and
a holder holding the PTC heating resistor and the metallic cooling body;
wherein the holder holds the fan and comprises a frame that surrounds the PTC heating resistor.
